(19) United States
(12) Patent Application Publication
(10) Pub. No.: US 2026/0039486 A1
(43) Pub. Date: Feb. 5, 2026

(54) VERIFYING DATA OBJECT VERSIONS USING AUTHENTICATION CODE

(71) Applicant: Rubrik, Inc., Palo Alto, CA (US)

(72) Inventors: Akriti Garg, Bengaluru (IN); Siddharth Goyal, Bengaluru (IN)

(21) Appl. No.: 18/790,378

(22) Filed: Jul. 31, 2024

(51) Int. Cl. H04L 9/32; H04L 9/08

(52) U.S. Cl. CPC H04L 9/3297; H04L 9/0825; H04L 9/3242

(57) ABSTRACT

Methods, systems, and devices for data management are described. A data management system (DMS) may identify, in accordance with a data recovery operation, a set of data object versions stored in a cloud storage system and associated with a data object identifier. The DMS may verify, using a cryptographic key, whether each data object version of the set of data object versions is associated with a respective valid signature stored in the cloud storage system. A valid signature for a data object version of the set of data object versions may be generated using a timestamp associated with upload of the data object version and the data object identifier. The DMS may obtain the data object version that is associated with the respective valid signature that is generated using a most recent timestamp among one or more timestamps associated with the set of data object versions.

### FIELD OF TECHNOLOGY

The present disclosure relates generally to data management, including techniques for verifying data object versions using authentication code.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports verifying data object versions using authentication code in accordance with aspects of the present disclosure.

FIG. 2 shows an example of a systems diagram that supports verifying data object versions using authentication code in accordance with aspects of the present disclosure.

FIG. 3 shows an example of a process flow that supports verifying data object versions using authentication code in accordance with aspects of the present disclosure.

FIG. 4 shows a block diagram of an apparatus that supports verifying data object versions using authentication code in accordance with aspects of the present disclosure.

FIG. 5 shows a block diagram of a verification component that supports verifying data object versions using authentication code in accordance with aspects of the present disclosure.

FIG. 6 shows a diagram of a system including a device that supports verifying data object versions using authentication code in accordance with aspects of the present disclosure.

FIGS. 7 through 9 show flowcharts illustrating methods that support verifying data object versions using authentication code in accordance with aspects of the present disclosure.

### DETAILED DESCRIPTION

A data management system (DMS) (e.g., a customer data management (CDM) system or owner cluster of the DMS) or a client environment may upload encrypted data to a cloud storage system (e.g., cloud server). For example, the DMS may upload data objects to a cloud storage system. The cloud server may support immutability, such that the data objects cannot be modified on the cloud server. For example, changes to data objects on a data management system do not result in changes to the data object on the cloud server. Rather, updates to the data objects may result in additional versions of the data objects. A request for such a data object (e.g., in a data recovery procedure) may result in the cloud server returning the latest version of the data object. However, a bad actor could upload a new “version” of a data object that contains malicious information (e.g., virus, ransomware), and a recovery of the data object may result in the malicious data object being downloaded to the data management system or the customer environment.

According to techniques described herein, the DMS or computing environment that is retrieving a data object (e.g., a reader cluster) may identify a correct or valid data object version (e.g., a data object version of the data object not generated by the malicious user). For data object upload, the DMS may generate an advanced encryption standard (AES) key, and the DMS may store an encrypted version of the AES key in the cloud storage system. When the DMS uploads a particular data object to the cloud storage system, the DMS may generate a signature using a hash-based message authentication code (HMAC), the AES key, a current timestamp, and a file path or key value of the data object in the cloud storage system. Each data object version of the data object may include a unique signature based on the current timestamp. The signature may be included in metadata associated with the data object.

When downloading the data object from the cloud storage system, a reader cluster (e.g., a DMS) may iterate through all versions of the data object and download the data object version associated with metadata including a signature of the latest or most recent encrypted timestamp. In some examples, the malicious data object versions of the data object may lack an encrypted timestamp and may be ignored by the reader cluster. In some examples, malicious data object versions of the data object may include duplicative metadata of an existing data object version. The reader cluster may identify the correct or valid data object version of the data object by selecting the earliest written data object version of the data object with the latest encrypted timestamp. The valid or correct data object version of the data object may be written earlier than the malicious data object version associated with the same metadata. Thus, these techniques may limit or prevent download of malicious or corrupt data objects from a cloud storage system. These and other techniques are described in further detail with respect to the figures.

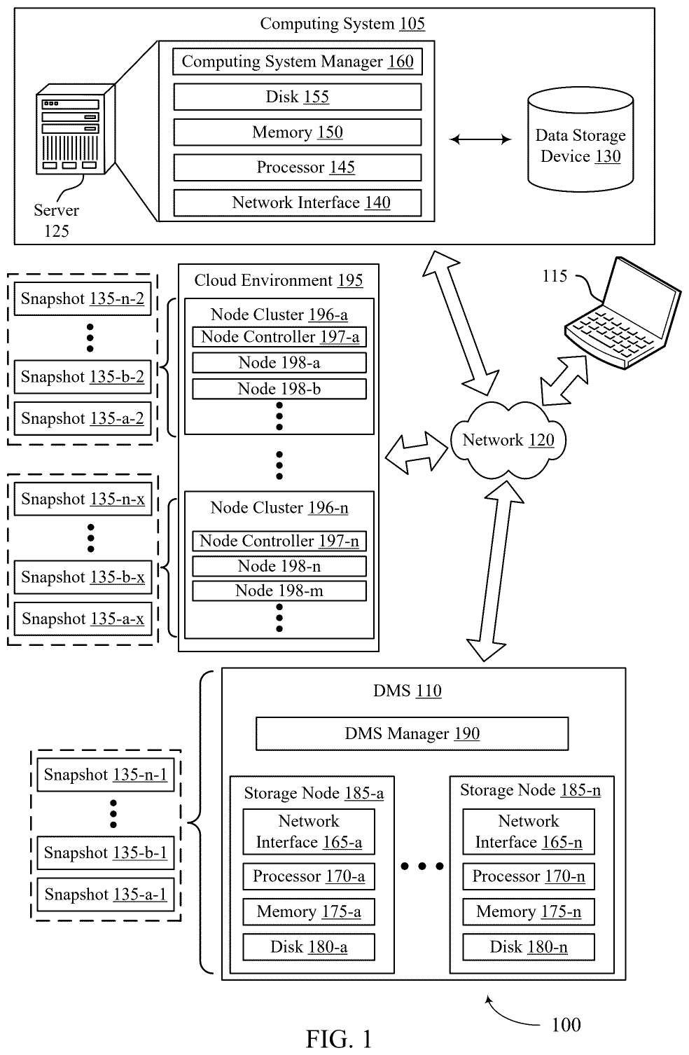

FIG. 1 illustrates an example of a computing environment 100 that supports verifying data object versions using authentication code in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

As described herein, the DMS 110 and/or a production environment (e.g., the computing system 105) may leverage the cloud environment 195 for additional backup and data storage for data objects such as backup snapshots, files, etc. For example, the DMS 110 may store snapshots 135 to the cloud environment 195 and/or the computing system 105 may store files to the cloud environment 195. The cloud environment 195 may implement immutability and/or versioning techniques such that updates to data objects backed up to the cloud environment 195 result in new versions of the data object at the cloud environments 195 rather than updating the existing backup at the cloud environment. When a backup of a data object is to be obtained from the cloud environment, the cloud environment 195 may be configured to return the latest version without consideration of whether the latest version has been accessed or updated in an unauthorized manner such that the latest version may contain malicious information (e.g., malware or ransomware).

According to techniques described herein, a computing system (e.g., computing system 105 and/or DMS 110) may identify a correct or valid data object version (e.g., a data object version of the data object not updated in an unauthorized manner) stored on a cloud storage system (e.g., the cloud environment 195). For example, the DMS 110 may generate an AES key, and the DMS 110 may store an encrypted version of the AES key in the cloud storage system. When the DMS 110 uploads a data object to the cloud storage system, the DMS 110 may generate a signature using an HMAC, the AES key, a current timestamp, and a file path or key value of the data object in the cloud storage system. Each data object version of the data object may include a unique signature based on the current timestamp. The signature may be included in metadata associated with the data object.

When downloading the data object from the cloud storage system, DMS 110 (e.g., another instance of the DMS 110, such as a reader cluster) may iterate through all versions of the data object and download the data object version associated with metadata including a signature of the latest or most recent encrypted timestamp. In some examples, the malicious data object versions of the data object may lack an encrypted timestamp and may be ignored by the reader cluster of the DMS 110. In some examples, malicious data object versions of the data object may include duplicative metadata of an existing data object version. The DMS 110 may identify the correct or valid data object version of the data object by selecting the earliest written data object version of the data object with the latest encrypted timestamp. The valid or correct data object version of the data object may be written earlier than the malicious data object version associated with the same metadata.

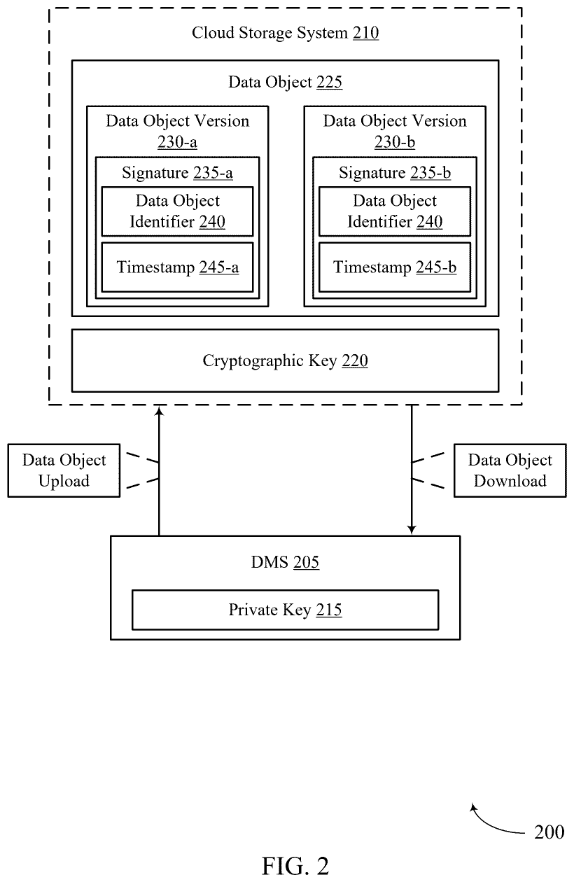

FIG. 2 shows an example of a systems diagram 200 that supports verifying data object versions using authentication code in accordance with aspects of the present disclosure. The systems diagram 200 may implement or be implemented by aspects of the computing environment 100 described with reference to FIG. 1. For example, the systems diagram 200 may include a DMS 205, which may represent an example of a DMS 110 as described with reference to FIG. 1. The DMS 205 may be an example of an owner cluster (e.g., an authorized cluster that originally uploaded data objects to a cloud storage system 210), a reader cluster (e.g., an authorized cluster that is to download the data objects from the cloud storage system 210), or both. That is, different DMSs 205 may be used for upload and download. For example, a first DMS 205 may upload/backup data objects to the cloud storage system 210, but the first DMS 205 may experience a failure. As such, a second DMS 205 may be instantiated and may access the cloud storage system 210 to download the data objects for a restore/recovery operation. The systems diagram 200 may include cloud storage system 210, which may represent an example of a cloud environment 195.

The DMS 205 may upload and download data objects 225 to and from the cloud storage system 210 for data backup and recovery. The DMS 205 may utilize the cloud storage system 210 to support additional functionalities such as versioning and immutability. For example, the DMS 205 (e.g., as an owner cluster) may upload a data object 225. The cloud storage system 210 may store the data object 225 as a first data object version 230-a. The first data object version 230-a may represent the data object 225 at the time of being uploaded by the owner cluster. The DMS 205 may include a private key 215 (e.g., an Rivest Shamir Adleman (RSA) key). The DMS 205 may encrypt or decrypt the data objects 225 using the private key 215 prior to uploading or downloading the data objects 225 to the cloud storage system 210. In some cases, the private key 215 may be provided by a user or system associated with the data objects 225.

An immutability and versioning procedure at the cloud storage system 210 may prevent data loss. For example, the immutability procedure at the cloud storage system 210 may prevent the DMS 205 from updating or changing the first data object version 230-a at the cloud storage system 210 after upload. However, the data object may be updated or modified at the DMS 205, but the versioning procedure at the cloud storage system 210 may result in a new version of the data object at the cloud storage system 210 for backup of the data object (rather than an update of the previously uploaded version).

For example, if the DMS 205 makes an update to the data object 225 (e.g., as a result of an update at a production environment), the update may be stored as a new data object version 230. For example, if the DMS 205 updates data associated with the data object 225 and uploads the data object 225 to the cloud storage system 210, the cloud storage system 210 may generate a second data object version 230-b. The second data object version 230-b may represent the data object 225 after the updates made by the DMS 205. The first data object version 230-a may be preserved after the generation of the second data object version 230-b based on the immobility and versioning procedures at the cloud storage system 210. A set of data object versions associated with the data object 225 may include the first data object version 230-a and the second data object version 230-b, among other versions.

When the DMS 205 performs any operation associated with a locked file (e.g., a file or data object associated with the immutability procedure), a new data object version 230 of the file is created. A new data object version 230 may be created due to a valid operation (e.g., an operation performed by an authenticated user), or a malicious operation performed by a malicious actor. In some examples, the DMS 205 may be unable to identify a most recent valid data object version 230. That is, the DMS 205 may be unable to identify a most recent data object version 230 not created due to a malicious operation (e.g., a correct or valid version for a file). For example, a malicious actor may connect to the cloud storage system 210 prior to the DMS 205 connecting to the cloud storage system 210, and the malicious actor may perform malicious operations generating malicious data object versions 230.

In some examples, the original DMS 205 may experience a data loss event. For example, the DMS 205 may lose the local versioning metadata on the owner cluster. Additionally, or alternatively, the DMS 205 or the local versioning metadata may be unavailable. Such a data loss event may result in the DMS 205 and/or a new instance of the DMS being unable to determine if any of the multiple data object versions 230 are valid or were generated based on a malicious operation.

According to techniques described herein, the DMS 205 may utilize signatures 235 based on a cryptographic key 220 (e.g., a specific encryption key) and timestamps 245 in accordance with a data backup operation (e.g., object upload). For example, the DMS 205 may generate a HMAC (e.g., signature, digest) generated using the cryptographic key 220 and the timestamp 245 to tag each data object version 230. When uploading the data object 225 the DMS 205 may generate a first signature 235-a based on a data object identifier 240 (e.g., a file path associated with the data object 225 on the cloud storage system 210, a key value associated with the data object 225, or both), the cryptographic key 220, and a timestamp 245 associated with the generation of the first signature 235-a. The DMS 205 may store the signature 235 in metadata associated with the first data object version 230-a. In some examples, the signature 235 may include a first signature based on the data object identifier 240 and a second signature based on the timestamp 245. In some examples, the signature 235 may include a single signature based on the data object identifier 240 and the timestamp 245.

The DMS 205 may generate the cryptographic key 220. The cryptographic key may be encrypted using the private key 215. The cryptographic key 220 may be an example of an AES key and may be stored on the cloud storage system 210. The cryptographic key generation (e.g., the HMAC key generation) and verification may not rely on any persistence of data other than the immutable storage of the cloud storage system 210. For example, the cryptographic key 220 be associated with a third signature 235 (not shown). The third signature may be based on a data object identifier 240 of the cryptographic key 220 and a timestamp 245 associated with the generation of the third signature 235. The DMS 205 may self-verify modification to the cryptographic key 220 using techniques described herein.

The timestamps 245 and the cryptographic key 220 may ensure that the DMS 205 may obtain the correct or valid data object version 230 without storing version identifiers at the reading cluster or anywhere else. The communication flow between the reading cluster of the DMS and the cloud storage system 210 may be self-contained and may not utilize any external input.

Logic at the DMS 205 that identifies the most recent valid data object version 230 (e.g., a correct version for a file) may include additional checks to get the valid data object version 230 even if the HMAC is duplicated as is across multiple versions by a malicious actor.

In an illustrative example, the owner cluster of the DMS 205 may upload the data object 225 to the cloud storage system 210. For example, the DMS 205 may calculate a first timestamp 245-a (e.g., a current timestamp). The first timestamp 245-a may be an example of a formatted date string or a coordinated universal time (UTC) epoch timestamp. The DMS 205 may calculate a first signature 235-a using an HMAC signed with the first timestamp 245-a as well as a first data object identifier 240 (e.g., a file path associated with the data object 225 on the cloud storage system 210 or key) to which the data object 225 is being uploaded. The cloud storage system 210 may store the uploaded data in a first data object version 230-a, and the cloud storage system may store the first signature 235-a in metadata associated with the first data object version 230-a.

If there are multiple uploads for the same data object identifier 240 from the DMS 205, each version may be associated with unique metadata including unique timestamps and signatures. For example, the owner cluster of the DMS 205 may update or change the data object 225, and the DMS 205 may upload the data object 225 to the cloud storage system 210 again. For example, the DMS 205 may calculate a second signature 235-b using an HMAC signed with a second timestamp 245-b later than the first timestamp 245-a and a second data object identifier 240. If the first data object identifier 240 and the second data object identifier 240 are the same, the first signature 235-a and the second signature 235-b may be unique based on the first timestamp 245-a being different from the second timestamp 245-b. The cloud storage system 210 may store the updated data object 225 in a second data object version 230-b. The cloud storage system 210 may store the second signature 235-b in metadata associated with the second data object version 230-b.

The DMS 205 (e.g., a cluster of the DMS 205 that includes the private key 215) may download the data object 225 for a recovery operation. When downloading the content for the data object identifier 240 (e.g., the file path or the key value) associated with the data object 225, the DMS 205 may perform a list operation for all data object versions 230 of data object 225 (e.g., all data object versions associated with the key or data object identifier 240). The DMS 205 may iterate through all data object versions 230 and download the data object version 230 associated with the signature 235 stored in the metadata including the highest, latest, or most recent encrypted timestamp. The DMS 205 may decrypt the signatures 235 using the cryptographic key 220 to identify the most recent timestamp 245. For example, the reader cluster of the DMS 205 may download the second data object version 230-b based on the metadata associated with the second data object version 230-b including an encrypted timestamp of the second timestamp 245-b and the second timestamp 245-b being later than the first timestamp 245-a.

A malicious actor may not be able to write a properly formatted encrypted timestamp (e.g., a signature 235). For example, the attacker may not have access to the private key 215. Without access to the private key 215, the attacker may be unable to decrypt the cryptographic key 220 stored on the cloud storage system 210.

Any data object versions 230 associated with metadata that lacks the encrypted timestamp (e.g., signature 235) may be ignored by the reader cluster of the DMS 205. For example, the reader cluster of the DMS 205 may determine that an invalid data object version 230 (e.g., a data object version generated based on a malicious operation) was not written by the DMS 205 and therefore ignore the invalid data object versions 230.

In some examples, a malicious actor may generate valid metadata by copying existing metadata. For example, a malicious attacker may upload changes to the data object 225, and the malicious attacker may copy the second signature 235-b associated with a most recent data object version 230 The cloud storage system 210 may store the changed data object 225 as a third data object version 230. Even if the malicious actor copies the most recently uploaded object metadata into metadata associated with the third object version 230, the DMS 205 may correctly select the valid data object version 230 (e.g., the second data object version 230-b) by selecting the earliest written data object version 230 associated with the latest encrypted timestamp.

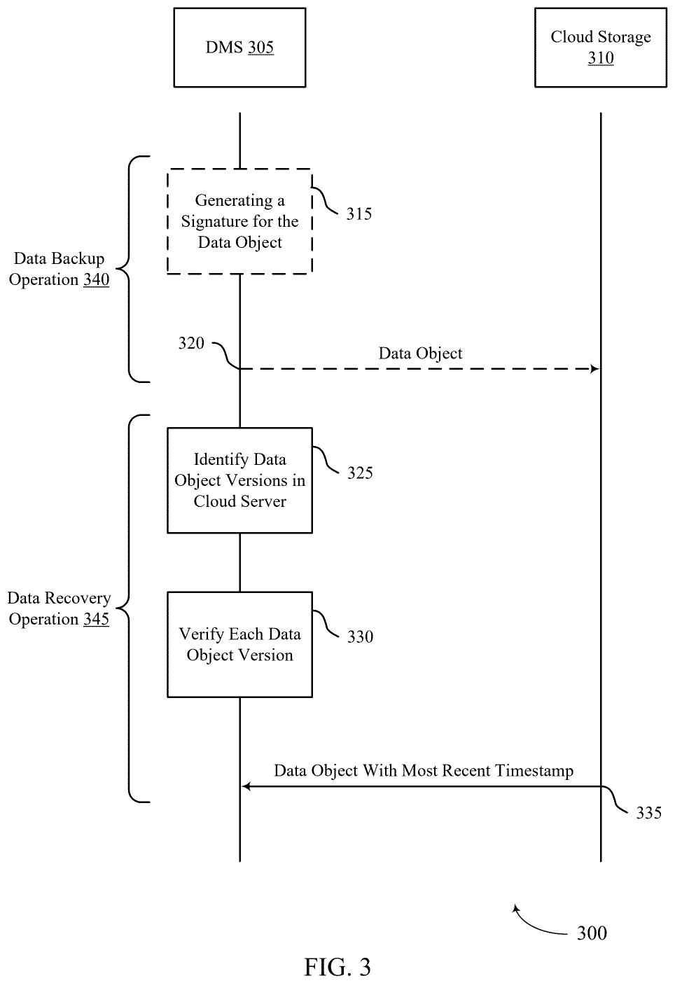

FIG. 3 shows an example of a process flow 300 that supports verifying data object versions using authentication code in accordance with aspects of the present disclosure. The process flow 300 may implement or be implemented by aspects of FIGS. 1 and 2. For example, the process flow 300 may be implemented by DMS 305 and a cloud storage system 310, which may represent examples of a corresponding DMS and cloud storage or cloud environment as described with reference to FIGS. 1 and 2. The cloud storage system 310 may implement a data object immutability procedure which locks each version of data objects from being modified.

In some examples, the DMS 305 may perform a data backup operation 340 and a data recovery operation 345. In some examples, a first DMS 305 may perform the data backup operation 340 and a second DMS 305 may perform the data recovery operation 345. That is, the first DMS 305 may experience a data loss or failure after one or more data backup operations 340, and the second DMS 305 may be instantiated and perform the data recovery operation 345 to download data objects.

In some cases, the DMS 305 may obtain, in accordance with the data backup operation 340 or the data recovery operation 345, the cryptographic key (e.g., the cryptographic key 220 as described with reference to FIG. 2) from the cloud storage system 310 in order to verify whether each data object version of a set of data object versions is associated with a respective valid signature. The DMS 305 may verify, in response to obtaining the cryptographic key and using a private key (e.g., the private key 215 described with reference to FIG. 2), the cryptographic key. The DMS may verify whether each data object version is associated with the respective valid signature in response to verifying the cryptographic key. The cryptographic key may be an AES key.

At 315, the DMS 305 may generate, in accordance with the data backup operation 340, a signature for a data object associated with a data object identifier. The signature may be generated using a timestamp and the data object identifier. The valid signature for the data object version may be generated using a HMAC function and the cryptographic key. The valid signature for the data object version of the set of data object versions may be stored in metadata associated with the data object version.

At 320, the DMS 305 may upload, in accordance with the data backup operation 340 and to the cloud storage system, the data object and the signature. The uploading may result in a new version of the data object associated with the data object identifier. In some cases, each data object version of the set of data object versions in the cloud storage system 310 may be encrypted using the private key. For example, the DMS 305 may encrypt the data object using the private key prior to uploading the data object to the cloud storage system 310.

At 325, the DMS 305 may identify, in accordance with a data recovery operation 345, a set of data object versions stored in a cloud storage system 310 and associated with a data object identifier. The data object identifier may be a file path associated with the set of data object versions, a key value associated with the set of data object versions, or both. In some cases, the DMS 305 may iterate through each data object version of the set of data object versions to identify the one or more timestamps associated with the set of data object versions.

At 330, the DMS 305 may verify, using a cryptographic key, whether each data object version of the set of data object versions is associated with a respective valid signature stored in the cloud storage system 310. A valid signature for a data object version of the set of data object versions may be generated using a timestamp associated with upload of the data object version and the data object identifier. The DMS 305 may verify each data object version or sets of data object versions for multiple data objects (e.g., data object identifiers) in accordance with the data recovery operation 345. The DMS 305 may decrypt the respective valid signature for each data object version of the set of data object versions using the cryptographic key. In some cases, the DMS 305 may verify whether each data object version is associated with the respective valid signature based on the data object immutability procedure being implemented by the cloud storage system 310.

At 335, the DMS 305 may obtain, from the set of data object versions, the data object version that is associated with the respective valid signature that is generated using a most recent timestamp among one or more timestamps associated with the set of data object versions. The DMS 305 may obtain the data object version associated with the most recent timestamp in accordance with the data recovery operation 345. In some cases (e.g., when at least two data object versions are associated with a most recent timestamp), the DMS may obtain the data object version from the at least two data object versions associated with the respective valid signature that is generated using the most recent timestamp based on the data object version being an earliest written version of the at least two data object versions. That is, if two data object versions have the same timestamp/signature, then the DMS 305 may obtain the version that was written to the cloud storage system 310 earliest. That is, the cloud storage system 310 may be referenced as a source of truth for write times to the cloud storage system 310. Thus, the cloud storage system 310 may maintain or document write times to the cloud storage system 310 as metadata, which may be used in such a determination. The DMS 305 may refrain from obtaining a second data object version based on the second data object version being associated with an invalid signature or based on the second data object version lacking an associated signature payload. When the DMS 305 obtains the data object version, the DMS 305 may decrypt the obtained data object version using a private key.

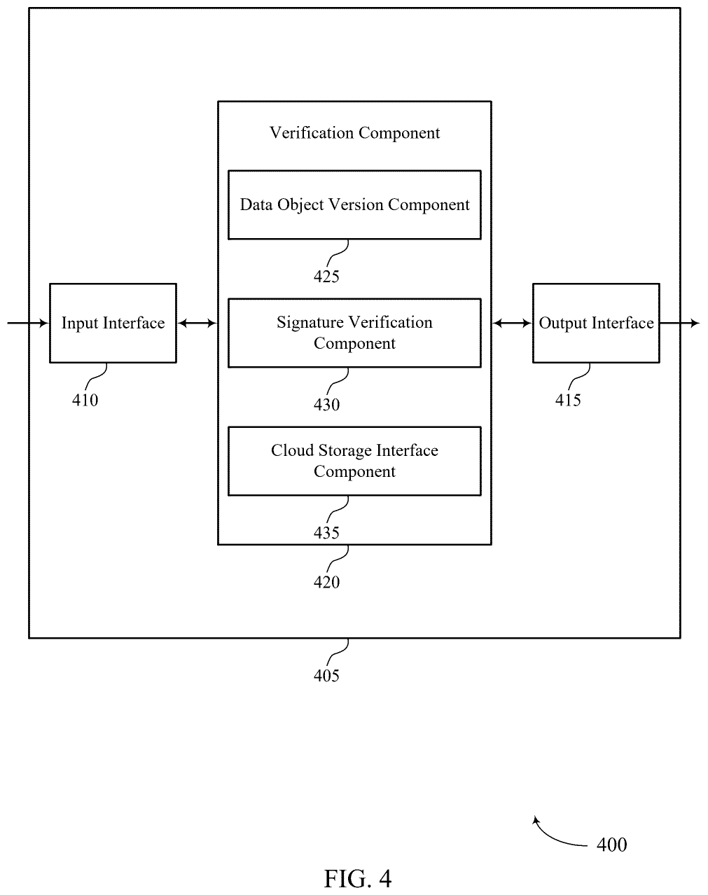

FIG. 4 shows a block diagram 400 of a system 405 that supports verifying data object versions using authentication code in accordance with aspects of the present disclosure. In some examples, the system 405 may be an example of aspects of one or more components described with reference to FIG. 1, such as a DMS 110. The system 405 may include an input interface 410, an output interface 415, and a verification component 420. The system 405 may also include one or more processors. Each of these components may be in communication with one another (e.g., via one or more buses, communications links, communications interfaces, or any combination thereof).

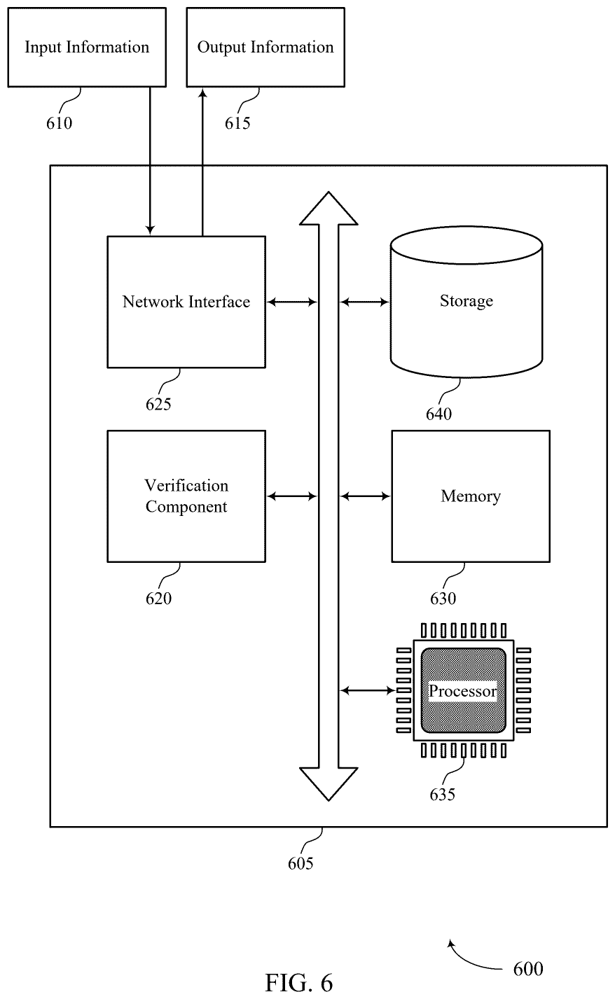

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the verification component 420 to support verifying data object versions using authentication code. In some cases, the input interface 410 may be a component of a network interface 625 as described with reference to FIG. 6.

The output interface 415 may manage output signaling for the system 405. For example, the output interface 415 may receive signaling from other components of the system 405, such as the verification component 420, and may transmit such output signaling corresponding to (e.g., representative of or otherwise based on) such signaling to other systems or devices. In some cases, the output interface 415 may be a component of a network interface 625 as described with reference to FIG. 6.

For example, the verification component 420 may include a data object version component 425, a signature verification component 430, a cloud storage interface component 435, or any combination thereof. In some examples, the verification component 420, or various components thereof, may be configured to perform various operations (e.g., receiving, monitoring, transmitting) using or otherwise in cooperation with the input interface 410, the output interface 415, or both. For example, the verification component 420 may receive information from the input interface 410, send information to the output interface 415, or be integrated in combination with the input interface 410, the output interface 415, or both to receive information, transmit information, or perform various other operations as described herein.

The data object version component 425 may be configured as or otherwise support a means for identifying, in accordance with a data recovery operation, a set of data object versions stored in a cloud storage system and associated with a data object identifier. The signature verification component 430 may be configured as or otherwise support a means for verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier. The cloud storage interface component 435 may be configured as or otherwise support a means for obtaining, from the set of data object versions, the data object version that is associated with the respective valid signature that is generated using a most recent timestamp among one or more timestamps associated with the set of data object versions.

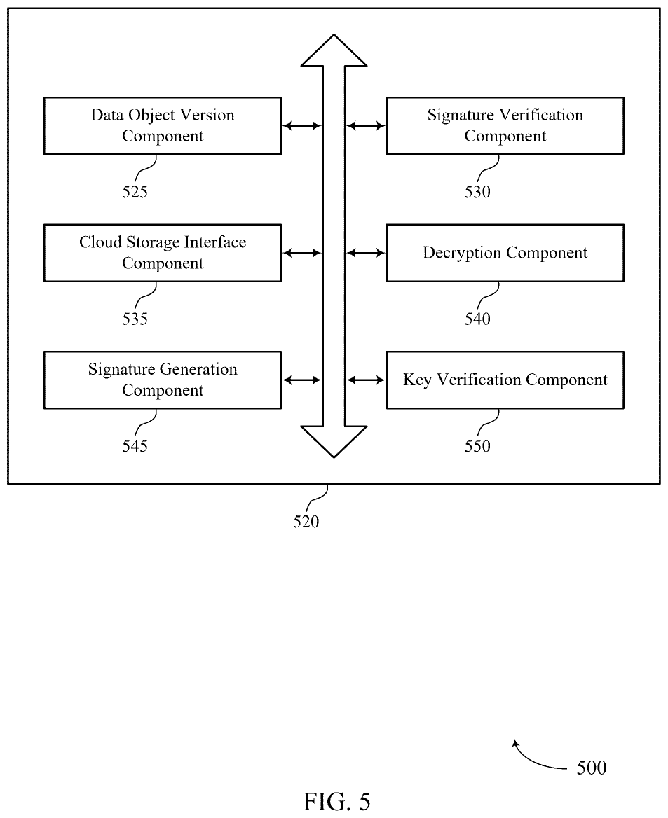

FIG. 5 shows a block diagram 500 of a verification component 520 that supports verifying data object versions using authentication code in accordance with aspects of the present disclosure. The verification component 520 may be an example of aspects of a verification component or a verification component 420, or both, as described herein. The verification component 520, or various components thereof, may be an example of means for performing various aspects of verifying data object versions using authentication code as described herein. For example, the verification component 520 may include a data object version component 525, a signature verification component 530, a cloud storage interface component 535, a decryption component 540, a signature generation component 545, a key verification component 550, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The data object version component 525 may be configured as or otherwise support a means for identifying, in accordance with a data recovery operation, a set of data object versions stored in a cloud storage system and associated with a data object identifier. The signature verification component 530 may be configured as or otherwise support a means for verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier. The cloud storage interface component 535 may be configured as or otherwise support a means for obtaining, from the set of data object versions, the data object version that is associated with the respective valid signature that is generated using a most recent timestamp among one or more timestamps associated with the set of data object versions.

In some examples, to support obtaining the data object version, the cloud storage interface component 535 may be configured as or otherwise support a means for obtaining the data object version from at least two data object versions associated with the respective valid signature that is generated using the most recent timestamp based on the data object version being an earliest written version of the at least two data object versions.

In some examples, the data object version component 525 may be configured as or otherwise support a means for iterating through each data object version of the set of data object versions to identify the one or more timestamps associated with the set of data object versions.

In some examples, to support verifying whether each data object version of the set of data object versions, the signature verification component 530 may be configured as or otherwise support a means for decrypting the respective valid signature for each data object version of the set of data object versions using the cryptographic key.

In some examples, the decryption component 540 may be configured as or otherwise support a means for decrypting the data object version using a private key, where each data object version of the set of data object versions in the cloud storage system are encrypted using the private key.

In some examples, the signature verification component 530 may be configured as or otherwise support a means for refraining from obtaining a second data object version based on the second data object version being associated with an invalid signature or based on the second data object version lacking an associated signature payload.

In some examples, the valid signature for the data object version is generated using a HMAC function and the cryptographic key.

In some examples, the signature verification component 530 may be configured as or otherwise support a means for obtaining, in accordance with the data recovery operation, the cryptographic key from the cloud storage system in order to verify whether each data object version is associated with the respective valid signature.

In some examples, the key verification component 550 may be configured as or otherwise support a means for verifying, in response to obtaining the cryptographic key and using a private key, the cryptographic key, where verifying whether each data object version is associated with the respective valid signature is performed in response to verifying the cryptographic key.

In some examples, the cryptographic key is an AES key.

In some examples, the valid signature for the data object version of the set of data object versions is stored in metadata associated with the data object version.

In some examples, the cloud storage system implements data object immutability procedure which locks each version of data objects from being modified and. In some examples, verifying whether each data object version is associated with the respective valid signature is performed based on the data object immutability procedure being implemented by the cloud storage system.

In some examples, the signature generation component 545 may be configured as or otherwise support a means for generating, in accordance with a data backup operation, a signature for a data object associated with a second data object identifier, where the signature is generated using a second timestamp and the second data object identifier. In some examples, the cloud storage interface component 535 may be configured as or otherwise support a means for uploading, in accordance with the data backup operation and to the cloud storage system, the data object and the signature, where the uploading results in a new version of the data object associated with the second data object identifier.

In some examples, the data object identifier is a file path associated with the set of data object versions, a key value associated with the set of data object versions, or a combination thereof.

FIG. 6 shows a block diagram 600 of a system 605 that supports verifying data object versions using authentication code in accordance with aspects of the present disclosure. The system 605 may be an example of or include components of a system 405 as described herein. The system 605 may include components for data management, including components such as a verification component 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting verifying data object versions using authentication code). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the verification component 620 may be configured as or otherwise support a means for identifying, in accordance with a data recovery operation, a set of data object versions stored in a cloud storage system and associated with a data object identifier. The verification component 620 may be configured as or otherwise support a means for verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier. The verification component 620 may be configured as or otherwise support a means for obtaining, from the set of data object versions, the data object version that is associated with the respective valid signature that is generated using a most recent timestamp among one or more timestamps associated with the set of data object versions.

By including or configuring the verification component 620 in accordance with examples as described herein, the system 605 may support techniques for verifying data object versions using authentication code, which may provide one or more benefits such as, for example, improved reliability, improved security, among other possibilities.

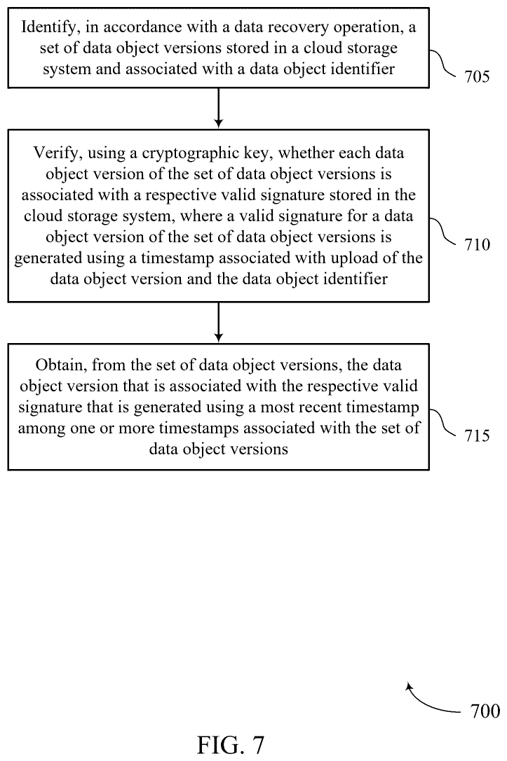

FIG. 7 shows a flowchart illustrating a method 700 that supports verifying data object versions using authentication code in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include identifying, in accordance with a data recovery operation, a set of data object versions stored in a cloud storage system and associated with a data object identifier. The operations of 705 may be performed in accordance with examples as disclosed herein. In some examples, aspects of the operations of 705 may be performed by a data object version component 525 as described with reference to FIG. 5.

At 710, the method may include verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier. The operations of 710 may be performed in accordance with examples as disclosed herein. In some examples, aspects of the operations of 710 may be performed by a signature verification component 530 as described with reference to FIG. 5.

At 715, the method may include obtaining, from the set of data object versions, the data object version that is associated with the respective valid signature that is generated using a most recent timestamp among one or more timestamps associated with the set of data object versions. The operations of 715 may be performed in accordance with examples as disclosed herein. In some examples, aspects of the operations of 715 may be performed by a cloud storage interface component 535 as described with reference to FIG. 5.

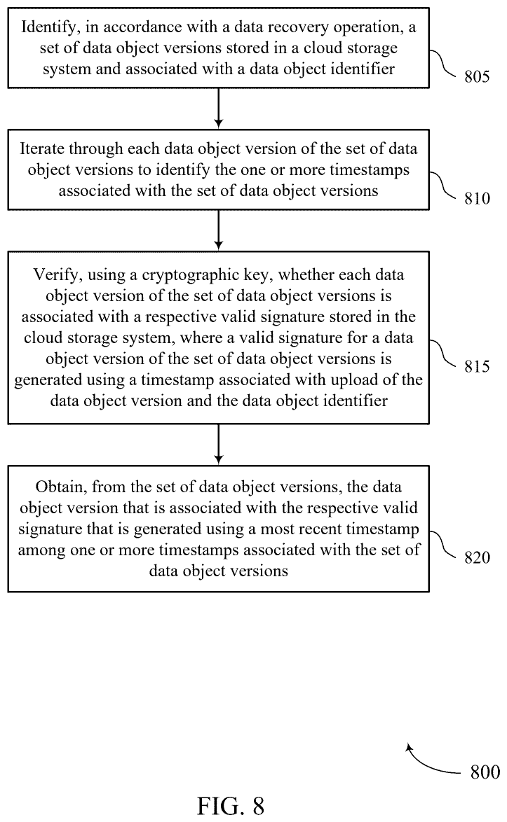

FIG. 8 shows a flowchart illustrating a method 800 that supports verifying data object versions using authentication code in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include identifying, in accordance with a data recovery operation, a set of data object versions stored in a cloud storage system and associated with a data object identifier. The operations of 805 may be performed in accordance with examples as disclosed herein. In some examples, aspects of the operations of 805 may be performed by a data object version component 525 as described with reference to FIG. 5.

At 810, the method may include iterating through each data object version of the set of data object versions to identify the one or more timestamps associated with the set of data object versions. The operations of 810 may be performed in accordance with examples as disclosed herein. In some examples, aspects of the operations of 810 may be performed by a data object version component 525 as described with reference to FIG. 5.

At 815, the method may include verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier. The operations of 815 may be performed in accordance with examples as disclosed herein. In some examples, aspects of the operations of 815 may be performed by a signature verification component 530 as described with reference to FIG. 5.

At 820, the method may include obtaining, from the set of data object versions, the data object version that is associated with the respective valid signature that is generated using a most recent timestamp among one or more timestamps associated with the set of data object versions. The operations of 820 may be performed in accordance with examples as disclosed herein. In some examples, aspects of the operations of 820 may be performed by a cloud storage interface component 535 as described with reference to FIG. 5.

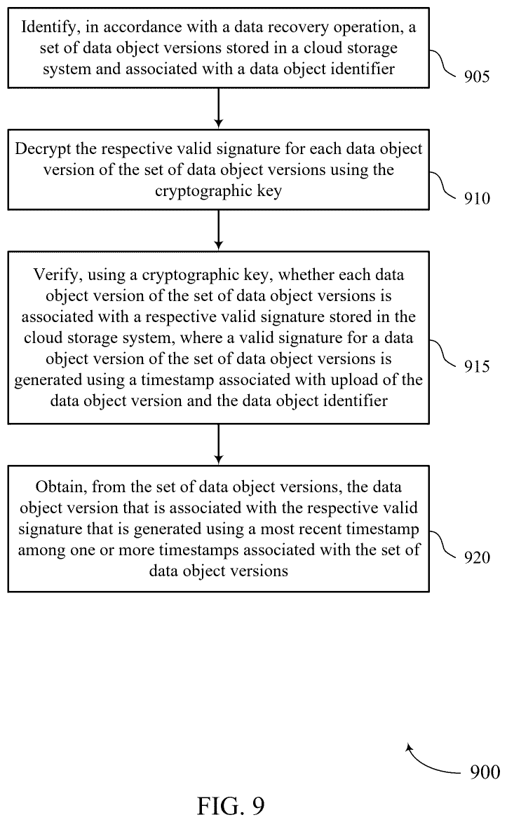

FIG. 9 shows a flowchart illustrating a method 900 that supports verifying data object versions using authentication code in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include identifying, in accordance with a data recovery operation, a set of data object versions stored in a cloud storage system and associated with a data object identifier. The operations of 905 may be performed in accordance with examples as disclosed herein. In some examples, aspects of the operations of 905 may be performed by a data object version component 525 as described with reference to FIG. 5.

At 910, the method may include decrypting the respective valid signature for each data object version of the set of data object versions using the cryptographic key. The operations of 910 may be performed in accordance with examples as disclosed herein. In some examples, aspects of the operations of 910 may be performed by a signature verification component 530 as described with reference to FIG. 5.

At 915, the method may include verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier. The operations of 915 may be performed in accordance with examples as disclosed herein. In some examples, aspects of the operations of 915 may be performed by a signature verification component 530 as described with reference to FIG. 5.

At 920, the method may include obtaining, from the set of data object versions, the data object version that is associated with the respective valid signature that is generated using a most recent timestamp among one or more timestamps associated with the set of data object versions. The operations of 920 may be performed in accordance with examples as disclosed herein. In some examples, aspects of the operations of 920 may be performed by a cloud storage interface component 535 as described with reference to FIG. 5.

A method by an apparatus is described. The method may include identifying, in accordance with a data recovery operation, a set of data object versions stored in a cloud storage system and associated with a data object identifier, verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier, and obtaining, from the set of data object versions, the data object version that is associated with the respective valid signature that is generated using a most recent timestamp among one or more timestamps associated with the set of data object versions.

An apparatus is described. The apparatus may include one or more memories storing processor executable code, and one or more processors coupled with the one or more memories. The one or more processors may individually or collectively be operable to execute the code to cause the apparatus to identify, in accordance with a data recovery operation, a set of data object versions stored in a cloud storage system and associated with a data object identifier, verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier, and obtain, from the set of data object versions, the data object version that is associated with the respective valid signature that is generated using a most recent timestamp among one or more timestamps associated with the set of data object versions.

Another apparatus is described. The apparatus may include means for identifying, in accordance with a data recovery operation, a set of data object versions stored in a cloud storage system and associated with a data object identifier, means for verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier, and means for obtaining, from the set of data object versions, the data object version that is associated with the respective valid signature that is generated using a most recent timestamp among one or more timestamps associated with the set of data object versions.

A non-transitory computer-readable medium storing code is described. The code may include instructions executable by one or more processors to identify, in accordance with a data recovery operation, a set of data object versions stored in a cloud storage system and associated with a data object identifier, verifying, using a cryptographic key, whether each data object version of the set of data object versions is associated with a respective valid signature stored in the cloud storage system, where a valid signature for a data object version of the set of data object versions is generated using a timestamp associated with upload of the data object version and the data object identifier, and obtain, from the set of data object versions, the data object version that is associated with the respective valid signature that is generated using a most recent timestamp among one or more timestamps associated with the set of data object versions.

In some examples of the method, apparatus, and non-transitory computer-readable medium described herein, obtaining the data object version may include operations, features, means, or instructions for obtaining the data object version from at least two data object versions associated with the respective valid signature that may be generated using the most recent timestamp based on the data object version being an earliest written version of the at least two data object versions.

Some examples of the method, apparatus, and non-transitory computer-readable medium described herein may further include operations, features, means, or instructions for iterating through each data object version of the set of data object versions to identify the one or more timestamps associated with the set of data object versions.

In some examples of the method, apparatus, and non-transitory computer-readable medium described herein, verifying whether each data object version of the set of data object versions may include operations, features, means, or instructions for decrypting the respective valid signature for each data object version of the set of data object versions using the cryptographic key.

Some examples of the method, apparatus, and non-transitory computer-readable medium described herein may further include operations, features, means, or instructions for decrypting the data object version using a private key, where each data object version of the set of data object versions in the cloud storage system may be encrypted using the private key.

Some examples of the method, apparatus, and non-transitory computer-readable medium described herein may further include operations, features, means, or instructions for refraining from obtaining a second data object version based on the second data object version being associated with an invalid signature or based on the second data object version lacking an associated signature payload.

In some examples of the method, apparatus, and non-transitory computer-readable medium described herein, the valid signature for the data object version may be generated using a HMAC function and the cryptographic key.

Some examples of the method, apparatus, and non-transitory computer-readable medium described herein may further include operations, features, means, or instructions for obtaining, in accordance with the data recovery operation, the cryptographic key from the cloud storage system in order to verify whether each data object version may be associated with the respective valid signature.

In some examples of the method, apparatus, and non-transitory computer-readable medium described herein, verifying, in response to obtaining the cryptographic key and using a private key, the cryptographic key, where verifying whether each data object version may be associated with the respective valid signature may be performed in response to verifying the cryptographic key.

In some examples of the method, apparatus, and non-transitory computer-readable medium described herein, the cryptographic key may be an AES key.

In some examples of the method, apparatus, and non-transitory computer-readable medium described herein, the valid signature for the data object version of the set of data object versions may be stored in metadata associated with the data object version.

In some examples of the method, apparatus, and non-transitory computer-readable medium described herein, the cloud storage system implements data object immutability procedure which locks each version of data objects from being modified and verifying whether each data object version may be associated with the respective valid signature may be performed based on the data object immutability procedure being implemented by the cloud storage system.

Some examples of the method, apparatus, and non-transitory computer-readable medium described herein may further include operations, features, means, or instructions for generating, in accordance with a data backup operation, a signature for a data object associated with a second data object identifier, where the signature may be generated using a second timestamp and the second data object identifier and uploading, in accordance with the data backup operation and to the cloud storage system, the data object and the signature, where the uploading results in a new version of the data object associated with the second data object identifier.

In some examples of the method, apparatus, and non-transitory computer-readable medium described herein, the data object identifier may be a file path associated with the set of data object versions, a key value associated with the set of data object versions, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
identifying, in accordance with a data recovery operation, a set of data object versions stored in a cloud storage system and associated with a data object identifier;
verifying, using a cryptographic key, whether each data object version of the set of data object versions is associated with a respective valid signature stored in the cloud storage system, wherein a valid signature for a data object version of the set of data object versions is generated using a timestamp associated with upload of the data object version and the data object identifier; and
obtaining, from the set of data object versions, the data object version that is associated with the respective valid signature that is generated using a most recent timestamp among one or more timestamps associated with the set of data object versions.

2. The method of claim 1, wherein obtaining the data object version further comprises:
obtaining the data object version from at least two data object versions associated with the respective valid signature that is generated using the most recent timestamp based at least in part on the data object version being an earliest written version of the at least two data object versions.

3. The method of claim 1, further comprising:
iterating through each data object version of the set of data object versions to identify the one or more timestamps associated with the set of data object versions.

4. The method of claim 1, wherein verifying whether each data object version of the set of data object versions further comprises:
decrypting the respective valid signature for each data object version of the set of data object versions using the cryptographic key.

5. The method of claim 1 further comprising:
decrypting the data object version using a private key, wherein each data object version of the set of data object versions in the cloud storage system are encrypted using the private key.

6. The method of claim 1 further comprising:
refraining from obtaining a second data object version based at least in part on the second data object version being associated with an invalid signature or based at least in part on the second data object version lacking an associated signature payload.

7. The method of claim 1, wherein the valid signature for the data object version is generated using a hash-based message authentication code function and the cryptographic key.

8. The method of claim 1, further comprising:
obtaining, in accordance with the data recovery operation, the cryptographic key from the cloud storage system in order to verify whether each data object version is associated with the respective valid signature.

9. The method of claim 8, further comprising:
verifying, in response to obtaining the cryptographic key and using a private key, the cryptographic key, wherein verifying whether each data object version is associated with the respective valid signature is performed in response to verifying the cryptographic key.

10. The method of claim 1, wherein the cryptographic key is an advanced encryption standard key.

11. The method of claim 1, wherein the valid signature for the data object version of the set of data object versions is stored in metadata associated with the data object version.

12. The method of claim 1, wherein the cloud storage system implements data object immutability procedure which locks each version of data objects from being modified and verifying whether each data object version is associated with the respective valid signature is performed based at least in part on the data object immutability procedure being implemented by the cloud storage system.

13. The method of claim 1, further comprising:
generating, in accordance with a data backup operation, a signature for a data object associated with a second data object identifier, wherein the signature is generated using a second timestamp and the second data object identifier; and
uploading, in accordance with the data backup operation and to the cloud storage system, the data object and the signature, wherein the uploading results in a new version of the data object associated with the second data object identifier.

14. The method of claim 1, wherein the data object identifier is a file path associated with the set of data object versions, a key value associated with the set of data object versions, or a combination thereof.

15. An apparatus, comprising:
one or more memories storing processor-executable code; and
one or more processors coupled with the one or more memories and individually or collectively operable to execute the code to cause the apparatus to:
identify, in accordance with a data recovery operation, a set of data object versions stored in a cloud storage system and associated with a data object identifier;
verify, using a cryptographic key, whether each data object version of the set of data object versions is associated with a respective valid signature stored in the cloud storage system, wherein a valid signature for a data object version of the set of data object versions is generated using a timestamp associated with upload of the data object version and the data object identifier; and
obtain, from the set of data object versions, the data object version that is associated with the respective valid signature that is generated using a most recent timestamp among one or more timestamps associated with the set of data object versions.

16. The apparatus of claim 15, wherein, to obtain the data object version, the one or more processors are individually or collectively further operable to execute the code to cause the apparatus to:
obtain the data object version from at least two data object versions associated with the respective valid signature that is generated using the most recent timestamp based at least in part on the data object version being an earliest written version of the at least two data object versions.

17. The apparatus of claim 15, wherein the one or more processors are individually or collectively further operable to execute the code to cause the apparatus to:
iterate through each data object version of the set of data object versions to identify the one or more timestamps associated with the set of data object versions.

18. The apparatus of claim 15, wherein, to verify whether each data object version of the set of data object versions, the one or more processors are individually or collectively further operable to execute the code to cause the apparatus to:
decrypt the respective valid signature for each data object version of the set of data object versions using the cryptographic key.

19. The apparatus of claim 15, wherein the one or more processors are individually or collectively further operable to execute the code to cause the apparatus to:
decrypt the data object version using a private key, wherein each data object version of the set of data object versions in the cloud storage system are encrypted using the private key.

20. A non-transitory computer-readable medium storing code, the code comprising instructions executable by one or more processors to:
identify, in accordance with a data recovery operation, a set of data object versions stored in a cloud storage system and associated with a data object identifier;
verify, using a cryptographic key, whether each data object version of the set of data object versions is associated with a respective valid signature stored in the cloud storage system, wherein a valid signature for a data object version of the set of data object versions is generated using a timestamp associated with upload of the data object version and the data object identifier; and
obtain, from the set of data object versions, the data object version that is associated with the respective valid signature that is generated using a most recent timestamp among one or more timestamps associated with the set of data object versions.
